(19) United States
(12) Patent Application Publication
(10) Pub. No.: US 2013/0260823 A1
(43) Pub. Date: Oct. 3, 2013

(54) Compact Portable Electronic Device Having Augmented Back Volume for Speaker

(71) Applicants: Ashutosh Y. Shukla, Santa Clara, CA (US); David A. Pakula, San Francisco, CA (US); Mathew D. Hill, Mountain View, CA (US); Richard Hung Minh Dinh, Cupertino, CA (US); Sawyer I. Cohen, Sunnyvale, CA (US); Terence N. Tam, San Francisco, CA (US)

(72) Inventors: Ashutosh Y. Shukla, Santa Clara, CA (US); David A. Pakula, San Francisco, CA (US); Mathew D. Hill, Mountain View, CA (US); Richard Hung Minh Dinh, Cupertino, CA (US); Sawyer I. Cohen, Sunnyvale, CA (US); Terence N. Tam, San Francisco, CA (US)

(21) Appl. No.: 13/436,924

(22) Filed: Mar. 31, 2012

(51) Int. Cl. H04M 1/00; H04R 1/02

(52) U.S. Cl. 455/556.1; 381/387

(57) ABSTRACT

Improved approaches to providing a sealed acoustic chamber (e.g., a back volume) for an acoustic component (e.g., speaker) resident in a compact portable electronic device are disclosed. In one embodiment, a compact portable electronic device includes an internal module (or housing), such as an optical camera module that includes optical components, which contains a module volume. The module volume can be provided with a port (e.g., opening) but is otherwise a substantially enclosed (e.g., at least substantially sealed) volume. By acoustically coupling the acoustic component to the port, the module volume can be used as some or all of the back volume for the acoustic component. Advantageously, a compact portable electronic can provide quality acoustic audio output while requiring only a limited amount of dedicated space.

### BACKGROUND OF THE INVENTION

Portable electronic devices typically include one or more speakers to provide audio output. The one or more speakers each may require a sealed acoustic chamber, such as a back volume. As portable electronic devices become smaller and more compact, it becomes increasingly difficult to provide an adequate acoustic chamber, which is important for good audio quality.

Conventionally, a dedicated area within a portable electronic device housing is used to provide an acoustic chamber for a speaker. The speaker is utilized by the portable electronic device to produce audio sound for the benefit of the user of the portable electronic device. For example, the speaker can produce audio sounds corresponding to music, movies or speech. Unfortunately, however, as electronic devices become increasingly more compact, the availability of space within a housing for a compact portable electronic device becomes more limited. This is even more difficult for camera modules that support auto-focus or zoom because such camera modules tend to be larger. Accordingly, given the constrained geometries and tight tolerances of compact portable electronic devices, such as handheld portable electronic devices, it is increasingly difficult to provide a speaker with an adequate acoustic chamber.

Thus, there is continuing need for improved techniques to provide acoustic chambers (e.g., back volumes) for speakers within compact portable electronic devices.

### SUMMARY

Improved approaches to providing a sealed acoustic chamber (e.g., a back volume) for an acoustic component (e.g., speaker) resident in a compact portable electronic device are disclosed. In one embodiment, a compact portable electronic device includes an internal module (or housing), such as an optical camera module that includes optical components, which contains a module volume. The module volume can be provided with a port (e.g., opening) but is otherwise a substantially enclosed (e.g., at least substantially sealed) volume of air. By acoustically coupling the acoustic component to the port, the module volume can be used as some or all of the back volume for the acoustic component. Advantageously, a compact portable electronic can provide quality acoustic audio output while requiring only a limited amount of dedicated space.

The compact portable electronic device has a housing. The housing of the portable electronic device can be compact, such as a low profile housing, and the housing can include the acoustic component, the internal module (e.g., optical camera module) and various other electrical or structural components. The portable electronic device can pertain to a portable digital media player, a mobile telephone, personal digital assistant, tablet computers, notebook computers, etc. According to one aspect of certain embodiments, an acoustic chamber (e.g., back volume) for a speaker can be formed internal to a housing for a portable electronic device using at least a volume maintained within another function module whose primary purpose is other than as a acoustic component.

Embodiments of the invention may be implemented in numerous ways, including, but not limited to, as a system, device, apparatus, or method. Example embodiments of the present invention are discussed below.

As a portable electronic device, one embodiment can, for example, include at least: an optical camera module including an optical stack and a module volume, the optical stack being provided internal to the module volume, the module volume having a port and an otherwise substantially enclosed volume of air; and an acoustic member acoustically coupled to the port of the optical camera volume. A back volume for the acoustic member is formed at least in part by the module volume of the optical camera module.

As a portable electronic device, one embodiment can, for example, include at least: an optical camera module including an optical stack provided internal to a module volume; an acoustic member; and a back volume coupled to the acoustic member. The back volume includes at least a substantial portion of the module volume.

As a method for forming a back volume for a speaker provided internal to a portable electronic device, one embodiment can, for example, include at least: providing a camera module having a camera housing with a camera housing port, wherein, other than the camera housing port, the camera housing providing a substantially contained first volume of air; providing an acoustic speaker having an acoustic speaker housing with a acoustic speaker port, the acoustic speaker housing providing a substantially contained second volume of air; and acoustically coupling the acoustic speaker port with the camera housing port so that a back volume is formed from both the first volume of air and the second volume of air.

As a portable electronic device having a housing, one embodiment can, for example, include at least: a printed circuit board; electrical components mounted on the printed circuit board; an EMI shielding structure attached to the printed circuit board, the EMI shielding structure be provided over one of more of the electrical components; a speaker module including a speaker; and an internal housing. The printed circuit board, the electrical components, the EMI shielding structure, the speaker module and the internal housing can all provided internal to the housing for the portable electronic device. The speaker module can contain a front volume for the speaker and a first portion of a back volume for the speaker. The internal housing contains a second portion of the back volume for the speaker. The first portion of the back volume is acoustically coupled to the second portion of the back volume.

Various aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, in which:

FIG. 1 illustrates an audio assembly according to one embodiment.

FIG. 2A is a cross-sectional view of an acoustic speaker according to one embodiment.

FIG. 2B is a cross-sectional view of an optical camera module according to one embodiment.

FIG. 2C is a crossed-sectional view of an assembly according to one embodiment.

FIG. 2D is a cross-sectional view of an assembly according to another embodiment.

FIG. 3 is a simplified sectional side view of a portable electronic device housing according to one embodiment.

FIG. 4 is a simplified sectional side view of a portable electronic device housing according to another embodiment.

FIG. 5 is a flow diagram of an acoustic sub-system assembly process according to one embodiment.

FIG. 6 is a flow diagram of an acoustic sub-system assembly process according to one embodiment.

### DETAILED DESCRIPTION OF EMBODIMENTS OF THE INVENTION

Improved approaches to providing a sealed acoustic chamber (e.g., a back volume) for an acoustic component (e.g., speaker) resident in a compact portable electronic device are disclosed. In one embodiment, a compact portable electronic device includes an internal module (or housing), such as an optical camera module that includes optical components, which contains a module volume. The module volume can be provided with a port (e.g., opening) but is otherwise a substantially enclosed (e.g., at least substantially sealed) volume or air. By acoustically coupling the acoustic component to the port, the module volume can be used as some or all of the back volume for the acoustic component. Advantageously, a compact portable electronic can provide quality acoustic audio output while requiring only a limited amount of dedicated space.

The compact portable electronic device has a housing. The housing of the portable electronic device can be compact, such as a low profile housing, and the housing can include the acoustic component, the internal module (e.g., optical camera module) and various other electrical or structural components. The portable electronic device can pertain to a portable digital media player, a mobile telephone, personal digital assistant, tablet computers, notebook computers, etc. According to one aspect of certain embodiments, an acoustic chamber (e.g., back volume) for a speaker can be formed internal to a housing for a portable electronic device using at least a volume of air maintained within another function module whose primary purpose is other than as a acoustic component.

The following detailed description is illustrative only, and is not intended to be in any way limiting. Other embodiments will readily suggest themselves to skilled persons having the benefit of this disclosure. Reference will now be made in detail to implementations as illustrated in the accompanying drawings. The same reference indicators will generally be used throughout the drawings and the following detailed description to refer to the same or like parts. It should be appreciated that the drawings are generally not drawn to scale, and at least some features of the drawings have been exaggerated for ease of illustration.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

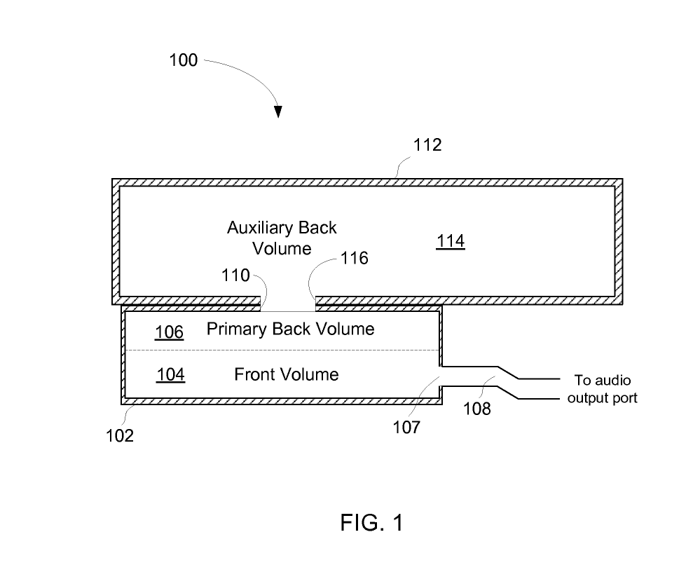

Embodiments of the invention are discussed below with reference to FIGS. 1-6. However, those skilled in the art will readily appreciate that the detailed description given herein with respect to these figures is for explanatory purposes as the invention extends beyond these limited embodiments. The illustrations provided in these figures are not necessarily drawn to scale; instead, the illustrations are presented in a manner to facilitate presentation.

FIG. 1 illustrates an audio assembly 100 according to one embodiment. The audio assembly 100 is, for example, a sub-assembly that is provided internal to a housing for a portable electronic device. The audio assembly 100 includes an acoustic speaker housing 102. The acoustic speaker housing 102 contains a speaker member (not shown) as well as a front volume 104 and a primary back volume 106. Within the acoustic speaker housing 102, the front volume 104 is acoustically isolated from the primary back volume 106. The speaker member within the acoustic speaker housing 102 can produce audio output from the front volume 104 that is directed through an opening 107 (or port) within the acoustic speaker housing 102. An audio channel 108 can also be coupled to the opening 106 so that the audio output can be conveyed or directed to an audio output port associated with the portable electronic device.

Although the acoustic speaker housing 102 includes a primary back volume 106, it is advantageous for enhanced audio quality to provide a larger volume for the back volume for the speaker member. Accordingly, in one embodiment, the acoustic speaker housing 102 includes an opening (or port) 110, which can be referred to as an acoustic speaker port. Coupled or adjacent to the opening 110 in the acoustic speaker housing 102 is a container 112. The container 112 includes an acoustically sealed volume of air, which can be referred to as an auxiliary back volume. The container 112 also includes a port 116. While the container 112 can have a primary purpose other than for providing a back volume to an acoustic speaker, as illustrated in FIG. 1, the auxiliary back volume 114 of the container 112 can be acoustically coupled to the primary back volume 106 of the acoustic speaker housing 102. For example, the opening 110 in the acoustic speaker housing 102 can be placed adjacent and aligned with the port 116 of the container 112. With such an arrangement, the effective back volume for the acoustic speaker is the combination of the primary back volume 106 together with the auxiliary back volume 114. In effect, the back volume for the acoustic speaker is substantially enlarged without requiring a dedicated acoustically sealed volume.

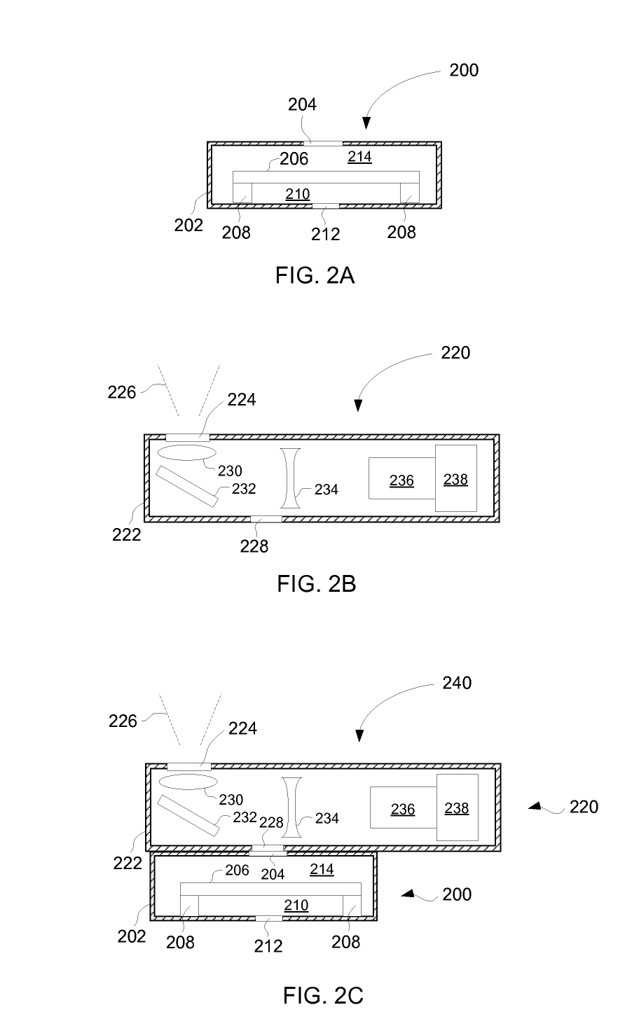

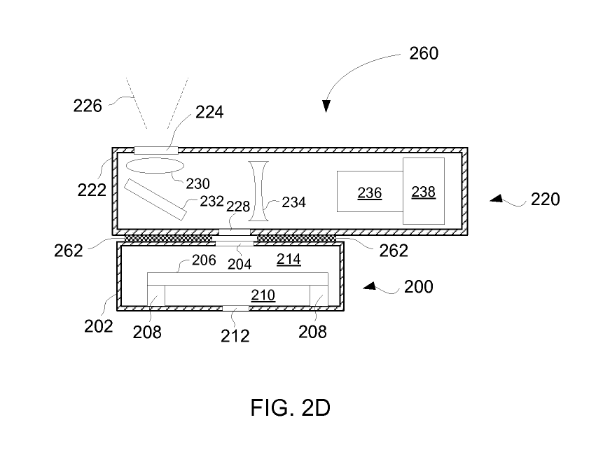

FIG. 2A is a cross-sectional view of an acoustic speaker 200 according to one embodiment. The acoustic speaker 200 includes an acoustic speaker housing 202 that includes a back volume port 204. The acoustic speaker housing 202 encloses a speaker member 206 that is secured within the acoustic speaker housing 202. In one embodiment, the speaker member 206 is secured with structures 208 (e.g., mounts) within the acoustic speaker housing 202. The acoustic speaker 200 is provided a front volume 210 as well as a front volume port 212. Audio output produced by the speaker member 206 can be output via the front volume port 212. The acoustic speaker housing 202 also supports a back volume 214 that is used by the speaker member 216 producing the audio output. In one embodiment, the speaker member 216 can be a disc type speaker. For example, the speaker member 216 is a piezoelectric device, such as a piezoelectric diaphragm, and in such case the acoustic speaker 200 can be referred to as a piezoelectric loudspeaker.

FIG. 2B is a cross-sectional view of an optical camera module 220 according to one embodiment. The optical camera module 220 includes an optical camera housing 222. The optical camera housing 222 includes a camera window 224 that allows a camera window 226 to be active external to the optical camera module 220. The optical camera housing 222 also includes a port 228. Internal to the optical camera housing 222 is a lens 230, a diverter 232, a concave lens 234, an image sensor 236, and a sensor movement device 238. The lens 230, the diverter 232, the concave lens 234 can be referred to as parts of an optical stack provided internal to the optical camera module 220. The optical stack, with the image sensor 236 and the sensor movement device 238, can support auto-focus or zoom functionality. The optical camera module 200 pertains to a folded optical camera module and can thus have a low profile which is suited for use in a compact portable electronic device. Of course, it should be understood that a optical camera module can be constructed in various other ways. For example, in another embodiment, a camera module can include an image sensor that is fixed and a lens system that makes use one or more movable lens.

FIG. 2C is a crossed-sectional view of an assembly 240 according to one embodiment. The assembly 240 includes a combination of the acoustic speaker housing 202 having the optical camera housing 222 coupled together to provide an enhanced back volume. In this regard, the back volume port 204 of the acoustic speaker housing 202 is placed adjacent and aligned with the port 228 of the optical camera housing 222. The coupling of the back volume port 204 of the acoustic speaker housing 202 to the port 228 of the optical camera housing 222 can be assisted with a seal (e.g., gasket, form-in-place sealant, adhesive interface, etc.). Advantageously, the resulting back volume for the acoustic speaker housing 202 is enlarged by the coupled volume of the optical camera housing 222. Although the volume of the optical camera housing 222 is associated with housing the various components of the optical camera, the volume can be made use of by the acoustic speaker 200 to augment its back volume.

The speaker member 206 within the acoustic speaker housing 202 can produce audio output from the front volume 210 that is directed through the front volume port 212 of the acoustic speaker housing 202. An audio channel (not shown) can also be coupled to the front volume port 212 so that the audio output can be conveyed or directed to an audio output port associated with a compact portable electronic device.

FIG. 2D is a cross-sectional view of an assembly 260 according to another embodiment. The assembly 260 generally similar to the assembly 240 illustrated in FIG. 2C. However, the assembly 260 illustrated in FIG. 2D further indicates the presence of an adhesive layer 262 placed between the adjacent surfaces of the acoustic speaker housing 202 and the optical camera housing 222. The adhesive layer 262 can serve to (i) secure together the acoustic speaker housing 202 and the optical camera housing 222, and (ii) seal (or substantially seal) the back volume port 204 with the port 228 of the optical camera housing 222.

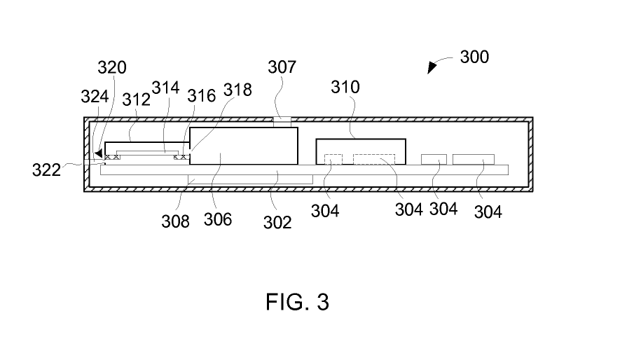

FIG. 3 is a simplified sectional side view of a portable electronic device housing 300 according to one embodiment. The portable electronic device housing 300 can represent an embodiment that includes, among other things, an assembly of an acoustic speaker housing and another housing (e.g., optical camera housing), such as the assembly 240 illustrated in FIG. 2C or the assembly 260 illustrated in FIG. 2D. The assembly can yield an enhanced speaker back volume in a space efficient manner.

The portable electronic device housing 300 encloses a printed circuit board 302. Various electrical components 304 can be attached to the printed circuit board 302. The electrical components 304 can pertain to integrated circuits, analog devices (e.g., resistor, capacitor, transistor), etc. that are often utilized by portable electronic devices. An optical camera module 306 and a display 308, which can be considered relatively large electrical components, can also be attached to the printed circuit board 302. The optical camera module 306 can include an optical stack and an image sensor.

In addition, the portable electronic device housing 300 can include an Electrical Magnetic Interference (EMI) shielding can 310. The EMI shielding can 310 can also be referred to as an RF can. The EMI shielding can 310 can be mounted on the printed circuit board 302. Typically, the EMI shielding can 310 covers or encloses one or more of the electrical components 304 so as to reduce EMI emissions.

Moreover, a speaker housing 312 can be secured within the portable electronic device housing 300. For example, the speaker housing 312 can be coupled to an upper surface of the printed circuit board 302. The speaker housing 312 can be secured with respect to the printed circuit board 302 by an adhesive seal. The adhesive seal can be provided around the bottom periphery of the speaker housing 312 to secure and substantially seal to the printed circuit board 302. In one embodiment, the speaker housing 312 can include a speaker 314, such as a piezoelectric speaker. In one implementation, the speaker 314 can be a disc type speaker. One or more structural members 316 can be provided within the speaker housing 312 to support the speaker 314 at, for example, its periphery.

In addition, the optical camera module 306 can be horizontally adjacent (or side-by-side) the speaker housing. The speaker housing 312 can be sealed to a portion of the optical camera module 306 via a port 318 (or opening). For example, the port 318 can be provided between a back volume within the speaker housing 312 and the internal volume of the optical camera module 306 (which is substantially sealed but for the port 318). The effective back volume for the speaker 314 is then the combination of the back volume within the speaker housing 312 and the internal volume within the optical camera module 306.

The speaker housing 312 can include at least one opening 320 in a front volume, which is acoustically isolated from the back volume. The opening 320 enables sound waves induced by the speaker 314 to propagate out from the speaker housing 312. The portable electronic device housing 300 also includes an opening 322, which can be referred to as an audio output port. The opening 322 can be coupled to a front volume for the speaker 314 via an acoustic chamber 324 so that sound waves generated by the speaker 314 can exit the portable electronic device housing 300. The opening 322 can be a dedicated opening for the speaker 314 or can alternatively be an opening that is also provided for another purpose (e.g., connector opening).

In this embodiment, the front volume for the speaker 314 is within the speaker housing 312 and is coupled to the opening 322 in the portable electronic device housing 300 so that audio output can be produced for a user of the portable electronic device. Also, in this embodiment, the back volume for the speaker 314 is provided in one part by a volume within the speaker housing 312 and provided in another part by a volume within the optical camera module 306.

Although in FIG. 3 the speaker housing 312 and the optical camera module 306 are provided horizontally adjacent (or side-by-side) within the portable electronic device housing 300, it should be understood that these components can be arranged in different positions or orientations. For example, in another embodiment, a speaker housing and an optical camera module could be vertically adjacent (or stacked) within the portable electronic device housing. Also, a speaker housing and an optical camera module need not be adjacent and could be separately positioned but acoustically coupled, such as with an acoustic chamber, within a portable electronic device housing. Additionally, is may be advantageous to orient of the air flow for the back volume in the optical cameral module such that the air flow is managed, so such can reduce any air disturbances to image capture by the optical camera module. For example, the air flow of the back volume can be configured to the substantially parallel to the lens. In another embodiment, the speaker can be disabled while an image is being captured by the optical camera module, which avoids any potential disturbances due to air flow from the back volume.

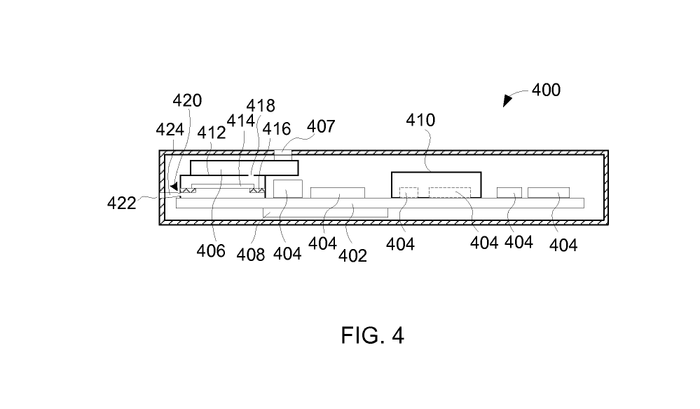

FIG. 4 is a simplified sectional side view of a portable electronic device housing 400 according to another embodiment. The portable electronic device housing 400 can represent an embodiment that includes, among other things, an assembly of an acoustic speaker housing and another housing (e.g., optical camera housing), such as the assembly 240 illustrated in FIG. 2C or the assembly 260 illustrated in FIG. 2D. The assembly can yield an enhanced speaker back volume in a space efficient manner.

The portable electronic device housing 400 encloses a printed circuit board 402. Various electrical components 404 can be attached to the printed circuit board 402. The electrical components 404 can pertain to integrated circuits, analog devices (e.g., resistor, capacitor, transistor), etc. that are often utilized by portable electronic devices. An optical camera module 406 and a display 408, which can be considered relatively large electrical components, can also be enclosed within the portable electronic device housing 400. The optical camera module 406 can include an optical stack and an image sensor.

In addition, the portable electronic device housing 400 can include an Electrical Magnetic Interference (EMI) shielding can 410. The EMI shielding can 410 can also be referred to as an RF can. The EMI shielding can 410 can be mounted on the printed circuit board 402. Typically, the EMI shielding can 410 covers or encloses one or more of the electrical components 404 so as to reduce EMI emissions.

Moreover, a speaker housing 412 can be secured within the portable electronic device housing 400. For example, the speaker housing 412 can be coupled to an upper surface of the printed circuit board 402. The speaker housing 412 can be secured with respect to the printed circuit board 402 by an adhesive seal. The adhesive seal can be provided around the bottom periphery of the speaker housing 412 to secure and/or substantially seal to the printed circuit board 402. In one embodiment, the speaker housing 412 can include a speaker 414, such as a piezoelectric speaker. In one implementation, the speaker 414 can be a disc type speaker. One or more structural members 416 can be provided within the speaker housing 412 to support the speaker 414 at, for example, its periphery.

In addition, the optical camera module 406 can be vertically adjacent (or stacked on) the speaker housing. The speaker housing 412 can be sealed to a portion of the optical camera module 406 via a port 418 (or opening). For example, the port 418 can be provided between a back volume within the speaker housing 412 and the internal volume of the optical camera module 406 (which is substantially sealed but for the port 418). The effective back volume for the speaker 414 is then the combination of the back volume within the speaker housing 412 and the internal volume within the optical camera module 406.

The speaker housing 412 can include at least one opening 420 in a front volume, which is acoustically isolated from the back volume. The opening 420 enables sound waves induced by the speaker 414 to propagate out from the speaker housing 412. The portable electronic device housing 400 also includes an opening 422, which can be referred to as an audio output port. The opening 422 can be coupled to a front volume for the speaker 414 via an acoustic chamber 424 so that sound waves generated by the speaker 414 can exit the portable electronic device housing 400. The opening 422 can be a dedicated opening for the speaker 414 or can alternatively be an opening that is also provided for another purpose (e.g., connector opening).

In this embodiment, the front volume for the speaker 414 is within the speaker housing 412 and is coupled to the opening 422 in the portable electronic device housing 400 so that audio output can be produced for a user of the portable electronic device. Also, in this embodiment, the back volume for the speaker 414 is provided in one part by a volume within the speaker housing 412 and provided in another part by a volume within the optical camera module 406.

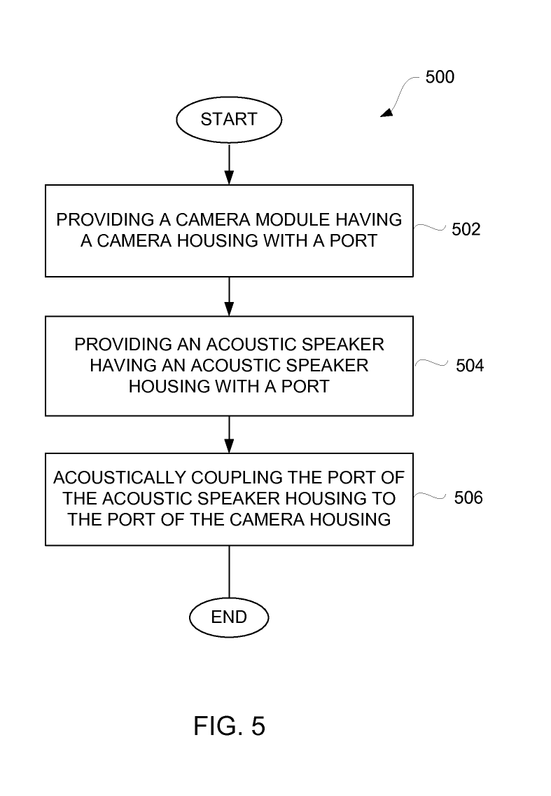

FIG. 5 is a flow diagram of an acoustic sub-system assembly process 500 according to one embodiment. The acoustic sub-system assembly process 500 can, for example, be performed to produce an acoustic sub-system assembly that is to be provided within a housing for a portable electronic device. The acoustic sub-system assembly allows for production of compact electronic devices that yield high-quality audio output. The acoustic sub-system assembly can, for example, be the assembly 240 illustrated in FIG. 2C or the assembly 260 illustrated in FIG. 2D. The acoustic sub-system assembly allows for production of compact electronic devices that yield high-quality audio output.

The acoustic sub-system assembly process 500 can initially provide 502 a camera module. The camera module can have a camera housing with a port. The port can refer to an opening in the camera housing. After such a suitable camera module has been provided, an acoustic speaker can be provided 504. The acoustic speaker can have an acoustic speaker housing with a port. The port in the acoustic speaker housing can refer to an opening in the acoustic speaker housing. Thereafter, the port of the acoustic speaker housing can be acoustically coupled 506 to the port of the camera housing. As a result, the back volume for the acoustic speaker is able to be substantially increased by coupling the camera module to the acoustic speaker. The resulting acoustic sub-system assembly has the acoustic speaker being acoustically coupled to the camera module. Since the ports of the acoustic speaker housing and the camera module are acoustically coupled, an acoustic chamber (e.g., substantially sealed volume) provided by the camera module is able to serve as an acoustic chamber (e.g., an auxiliary back volume) for the acoustic speaker. Following the block 506, the acoustic sub-system assembly process 500 can end.

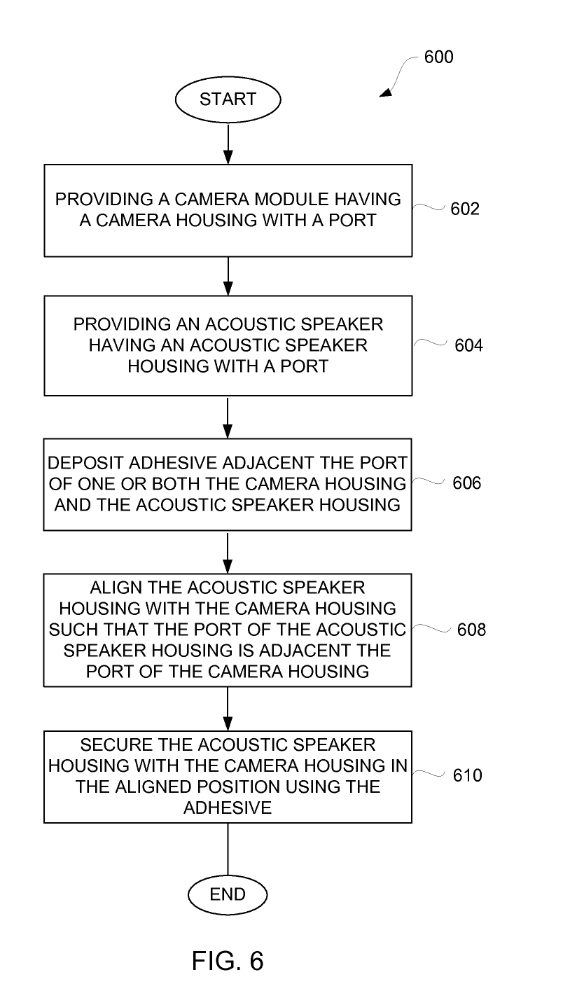

FIG. 6 is a flow diagram of an acoustic sub-system assembly process 600 according to one embodiment. The acoustic sub-system assembly process 600 can, for example, be performed to produce an acoustic sub-system assembly that is to be provided within a housing for a portable electronic device. The acoustic sub-system assembly can, for example, be the assembly 240 illustrated in FIG. 2C or the assembly 260 illustrated in FIG. 2D. The acoustic sub-system assembly allows for production of compact electronic devices that yield high-quality audio output.

The acoustic sub-system assembly process 600 can initially provide 602 a camera module. The camera module can have a camera housing with a port. The port can refer to an opening in the camera housing. After such a suitable camera module has been provided, an acoustic speaker can be provided 604. The acoustic speaker can have an acoustic speaker housing with a port. The port in the acoustic speaker housing can refer to an opening in the acoustic speaker housing. In one embodiment, the acoustic speaker can be a piezoelectric speaker.

After the camera module and the acoustic speaker have been provided, an adhesive can be deposited 606 adjacent the port of one or both the camera housing, and the acoustic speaker housing. The adhesive can be deposited 606 by a layer of adhesive or by other means (spray-on, bead, etc.). Next, the acoustic speaker housing can be aligned 608 with the camera housing such that the port of the acoustic speaker housing is adjacent to the port of the camera housing. Thereafter, the acoustic speaker housing can be secured 610 with the camera housing in the assigned position using the adhesive. Thereafter, the acoustic sub-system assembly has been formed with the acoustic speaker being acoustically coupled to the camera module. Since the ports of the acoustic speaker housing and the camera module are adjacent one another and aligned, an acoustic volume (e.g., substantially sealed volume) provided by the camera module is able to serve as an auxiliary back volume for the acoustic speaker housing. Following the block 610, the acoustic sub-system assembly process 600 can end.

Although the acoustic sub-system assembly process 600 uses adhesive to secure the acoustic speaker housing with the camera housing, in other embodiments, other means for securing can be used. For example, mechanical devices (e.g., screws, structural features, etc.) can be used alone or in combination with adhesive or sealants.

As described above, an optical camera module can refer to a dedicated container for an optical camera. For example, the optical camera module 220 illustrated in FIG. 2B, the optical camera module 306 in FIG. 3, or the optical camera module 406 in FIG. 4 are dedicated containers that contain a volume of air. These optical camera module is normally sealed, except for a port (or opening) for coupling with an acoustic component (e.g., speaker housing) and possibly also a vent hole (e.g., for pressure normalization). However, in other embodiments, the optical camera module can be provided without using a dedicated container. For example, instead of using a dedicated container for the optical camera volume, the optical camera volume can be provided integrated with the housing or other structures of an electronic device. The resulting optical camera volume can still be coupled to a speaker housing to provide an enhanced back volume. In one implementation, a confining structure for the optical camera volume can form a part of one or more surfaces of an inner housing surface, an internal chassis, an internal circuit board, an electromagnetic shield, an integrated circuit housing, or other structure internal to the housing for the electronic device.

According to another embodiment, a speaker can be used as an anti-dust mechanism. Here, the optical stack or the image sensor within an optical camera module can be hindered by the presence of dust in the optical camera module. The speaker, since it is acoustically coupled to the optical camera module, can be use to produce a pulse of air that serves to enter the optical camera module and dislodge any accumulated problematic dust. This anti-dust technique can be initiated on demand, automatically as needed, or automatically in accordance with a schedule.

A portable electronic device as discussed herein may be a hand-held electronic device. The term hand-held generally means that the electronic device has a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels.

Additional information on use of piezoelectric speakers and EMI shielding cans within electronic device housings can be found in U.S. patent application Ser. No. 12/236,452, filed Sep. 23, 2008, entitled “Electromagnetic Interference Shields with Piezos”, which is herein incorporated herein by reference.

Additional information on use of providing speakers within portable electronic device housings in a low profile manner can be found in U.S. patent application Ser. No. 12/240,519 , filed Sep. 29, 2008, entitled “Compact Housing for Portable Electronic Device with Internal Speaker”, which is herein incorporated herein by reference.

Also, as discussed above, a portable electronic device housing can include an opening (or aperture) so that sound waves generated by a speaker can exit the portable electronic device housing. When the opening is provided for another purpose (e.g., connector opening), it can be referred to as a dual-purpose aperture. Additional information on dual-purpose apertures can be found in U.S. patent application Ser. No. 12/016,584, filed Jan. 18, 2008, and entitled “DUAL-PURPOSE HARDWARE APERTURE”.

The advantages of the invention are numerous. Different embodiments or implementations may, but need not, yield one or more of the following advantages. One advantage of certain embodiments of the invention is that speakers can be used with compact housings for portable electronic devices while using minimal space within the housings. Another advantage of certain embodiments of the invention is that improved acoustic chambers can be provided within portable electronic device housings using non-dedicated areas internal thereto, such as internal modules or housings. For example, according to one embodiment, an acoustic chamber can yield high quality sound by using volumes from multiple different enclosed volumes that are acoustically coupled together.

The various aspects, features, embodiments or implementations of the invention described above can be used alone or in various combinations.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A portable electronic device, comprising:
an optical camera module including an optical stack and a module volume, the optical stack being provided internal to the module volume, the module volume having a port and an otherwise substantially enclosed volume of air; and
an acoustic member acoustically coupled to the port of the optical camera volume,
wherein a back volume for the acoustic member is formed at least in part by the module volume of the optical camera module.

2. A portable electronic device as recited in claim 1,
wherein the optical stack includes a plurality of lens, and
wherein the lens are positioned within the module volume so as to be substantially parallel to direction of air flow that is at times induced in the module volume by the acoustic member.

3. A portable electronic device as recited in claim 1, wherein the acoustic member is acoustically sealed to the port of the optical camera volume.

4. A portable electronic device as recited in claim 1, wherein the acoustic member is acoustically sealed to an intermediate volume, and the intermediate volume is acoustically sealed to the port of the optical camera volume.

5. A portable electronic device as recited in claim 1, wherein the optical stack is a folded optical stack.

6. A portable electronic device as recited in claim 1, wherein the acoustic member is a speaker.

7. A portable electronic device as recited in claim 1, wherein the portable electronic device is a mobile multi-function electronic device having a camera and an audio playback capability.

8. A portable electronic device as recited in claim 1, wherein the portable electronic device is a mobile phone having a camera and an audio playback capability.

9. A portable electronic device as recited in claim 8,
wherein the acoustic member is a speaker, and
wherein the optical stack is a folded optical stack.

10. A portable electronic device as recited in claim 9, wherein the acoustic member is acoustically sealed to the port of the optical camera volume or an intermediate volume.

11. A portable electronic device as recited in claim 10,
wherein the optical stack includes a plurality of lens, and
wherein the lens are positioned within the module volume so as to be substantially parallel to direction of air flow that is at times induced in the module volume by the acoustic member.

12. A portable electronic device, comprising:
an optical camera module including an optical stack provided internal to a module volume;
an acoustic member; and
a back volume coupled to the acoustic member,
wherein the back volume includes at least a substantial portion of the module volume.

13. A portable electronic device as recited in claim 12, wherein the optical stack is a folded optical stack.

14. A portable electronic device as recited in claim 12, wherein the acoustic member is a speaker.

15. A portable electronic device as recited in claim 12, wherein the acoustic member is acoustically sealed to the port of the optical camera volume.

16. A portable electronic device as recited in claim 12, wherein the acoustic member is acoustically sealed to an intermediate volume, and the intermediate volume is acoustically sealed to the port of the optical camera volume.

17. A portable electronic device as recited in claim 12, wherein the portable electronic device is a mobile multi-function electronic device having a camera and an audio playback capability.

18. A portable electronic device as recited in claim 12, wherein the portable electronic device is a mobile phone having a camera and an audio playback capability.

19. A portable electronic device as recited in claim 12,
wherein the optical stack includes a plurality of lens, and
wherein the lens are positioned within the module volume so as to be substantially parallel to direction of air flow that is at times induced in the module volume by the acoustic member.

20. A method for forming a back volume for a speaker provided internal to a portable electronic device, the method comprising:
providing a camera module having a camera housing with a camera housing port, wherein, other than the camera housing port, the camera housing providing a substantially contained first volume of air;
providing an acoustic speaker having an acoustic speaker housing with a acoustic speaker port, the acoustic speaker housing providing a substantially contained second volume of air; and
acoustically coupling the acoustic speaker port with the camera housing port so that a back volume is formed from both the first volume of air and the second volume of air.

21. A method as recited in claim 20, wherein the first volume of air is greater than the second volume of air.

22. A method as recited in claim 20, wherein the portable electronic device comprises a mobile phone.

23. A method as recited in claim 20, wherein the portable electronic device supports media playback using the acoustic speaker, and supports image capture using the camera module.

24. A method as recited in claim 20, wherein the method comprises:
determining when the camera module is in-use; and
disabling media playback while the camera module is in-use.

25. A portable electronic device having a housing, comprising
a printed circuit board;
electrical components mounted on the printed circuit board;
an EMI shielding structure attached to the printed circuit board, the EMI shielding structure be provided over one of more of the electrical components;
a speaker module including a speaker; and
an internal housing,
wherein the printed circuit board, the electrical components, the EMI shielding structure, the speaker module and the internal housing are all provided internal to the housing for the portable electronic device,
wherein the speaker module contains a front volume for the speaker and a first portion of a back volume for the speaker,
wherein the internal housing contains a second portion of the back volume for the speaker, and
wherein the first portion of the back volume is acoustically coupled to the second portion of the back volume.
